(19) United States
(12) Patent Application Publication
(10) Pub. No.: US 2026/0231844 A1
(43) Pub. Date: Aug. 13, 2026

(54) LEVELING BAR

(71) Applicants: Derek William KENT, Becker, MN (US); David Thomas PHANEUF, JR., Saint Cloud, MN (US)

(72) Inventors: Derek William KENT, Becker, MN (US); David Thomas PHANEUF, JR., Saint Cloud, MN (US)

(73) Assignee: CMP Attachments, LLC, Clear Lake, MN (US)

(21) Appl. No.: 19/427,637

(22) Filed: Dec. 19, 2025

Related U.S. Application Data
(60) Provisional application No. 63/740,439, filed on Dec. 31, 2024.

(51) Int. Cl. A01B 29/04; A01B 33/02; A01B 33/10

(52) U.S. Cl. CPC A01B 29/045; A01B 33/02; A01B 33/10

(57) ABSTRACT

A leveling bar includes ground-engaging bars depending from a frame to remove and redistribute ground material to level the ground. A rotatable drum with ground-engaging teeth assists in loosening the ground. The depth of cut of the drum can be adjusted by moving the drum relative to the bottom of the leveling bar, or by adding wear strips to the bottom of the leveling bar. Rotation of the drum is by a motor. The leveling bar can be connected to a skid-steer vehicle for movement across the ground and for providing hydraulic power to the motor.

### CROSS-REFERENCE TO RELATED APPLICATIONS

This application claims priority in U.S. patent application Ser. No. 63/740,439, filed Dec. 31, 2024, the contents of which are hereby incorporated by reference.

### BACKGROUND

### 1. Field of the Disclosed Subject Matter

The disclosed subject matter relates generally to soil-shifting equipment, and more particularly to a leveling bar.

### 2. Background

Earth working equipment is used to prepare the ground for recreational use, such as baseball infields, the application of sod, seed, or hard scape such as concrete material. Earth working equipment can be unpowered, such as a rake, powered and operator manipulated, such as a motorized tiller, or powered or unpowered and manipulated by motorized machinery.

Earth working equipment used to level uneven ground surfaces includes drags, frames baring teeth that engage the ground, wire mesh with weights, among others. These devices fail to produce a level surface, even if the surface is worked several times with the devices, due to a lack of sufficient contact with the entire surface being leveled to eliminate peaks and valleys, or insufficient means for moving such rigid or heavy equipment.

There is a need for more efficient tools to level and prepare large areas of ground for further use. Heretofore there has not been available an earth working tool with the advantages and features of the present disclosed subject matter.

### SUMMARY

In an implementation of the disclosed subject matter, an earth working leveling bar includes a frame with a plurality of ground engaging bars attached to the bottom of the frame forming front and rear cutting edges that engage the earth to create loose soil and debris. Adjacent the ground engaging bars is a rotating drum with protrusions that pulverize the earth to further loosen soil and debris. The distance the rotating protrusions extend below the ground engaging bars can be adjusted. The frame includes an attachment plate for connecting the leveling bar to a motorized vehicle, such as a skid-steer vehicle. Rotation of the drum can be powered by the hydraulic system of the vehicle.

In use, the vehicle moves the leveling bar forward across uneven or compacted ground surfaces causing the front cutting edges of the ground engaging bars to engage high spots of the earth, thereby removing material, including soil and debris, and distributing the loose material into low spots on the surface of the ground thereby leveling the surface of the ground. The drum may be rotated, further loosening soil and debris from the earth. Moving the leveling bar rearward causes the rear cutting edges of the ground engaging bars to engage the earth removing soil and debris from high spots, optionally aided by rotation of the drum, and distributing the loose material across the surface of the ground.

In an implementation, the skid-steer tilts the front of the leveling bar up and maintains contact between the rotating drum and the earth while moving the leveling bar forward and rearward to generate loose soil and debris. In an implementation, the skid-steer tilts the rear of the leveling bar up while maintaining contact between the ground engaging bar at the front of the leveling bar, and moves the leveling bar rearward causing the leveling bar to distribute the loose soil and debris across the surface of the ground and into low spots leveling the ground.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

The present disclosed subject matter is described herein with reference to the following drawing figures by way of example and are not limited by the accompanying figures for which like references indicate like elements, and with greater emphasis being placed on clarity rather than scale:

FIG. 1 is an isometric view from the front and above of a leveling bar according to aspects of the disclosed subject matter.

FIG. 2 is an isometric view from the rear and above of the leveling bar of FIG. 1.

FIG. 3 is an isometric view from the rear and below of the leveling bar of FIG. 1.

FIG. 4 is a top plan view of the leveling bar of FIG. 1.

FIG. 5 is a right-side elevation view of the leveling bar of FIG. 1.

FIG. 6 is a right-side elevation view of the leveling bar.

FIG. 7 is a right-side elevation view of the leveling bar.

FIG. 8 is an isometric view from the front and above of a leveling bar according to aspects of the disclosed subject matter.

FIG. 9 is an isometric view from the front of the leveling bar of FIG. 8.

FIG. 10 is an enlarged view of an aspect of the drum support assembly.

FIG. 11 is an enlarged view of an aspect of the drum support assembly.

FIG. 12 is an isometric view from the rear and above of the leveling bar of FIG. 8.

FIG. 13 is an isometric view from the rear and below of the leveling bar of FIG. 8.

FIG. 14 is a right-side elevation view of the leveling bar of FIG. 8.

FIG. 15 is a schematic diagram of the hydraulic system.

FIG. 16 is an isometric view from the front and above of a leveling bar according to aspects of the disclosed subject matter.

FIG. 17 is an isometric view from the rear and below of the leveling bar of FIG. 16.

### DETAILED DESCRIPTION

Certain terminology will be used in the following description for convenience in reference only and will not be limiting. For example, up, down, top, bottom, front, back, rear, right, left, forward, rearward, upward, and downward refer to the disclosed subject matter as orientated in the view being referred to, or in reference to such terminology designating the characteristics of an assembly as described in this description. Such terminology will include the words specifically mentioned, derivatives thereof, and words of similar meaning.

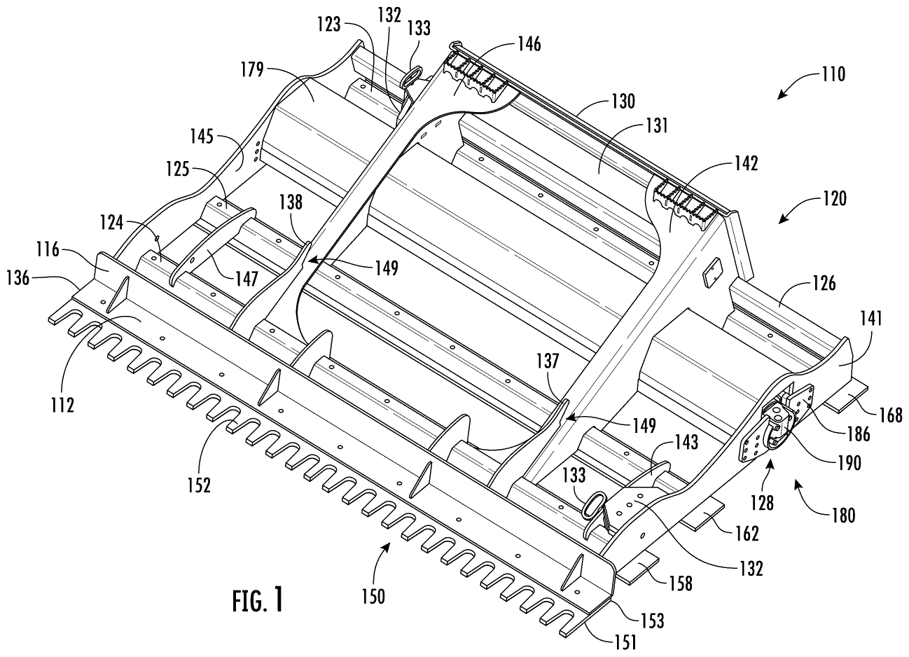

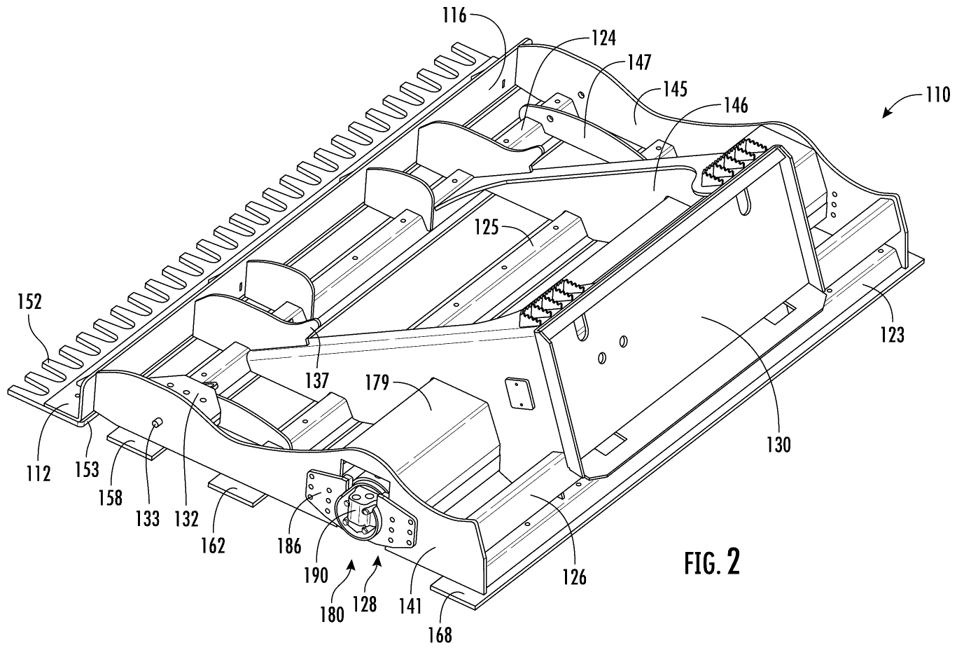

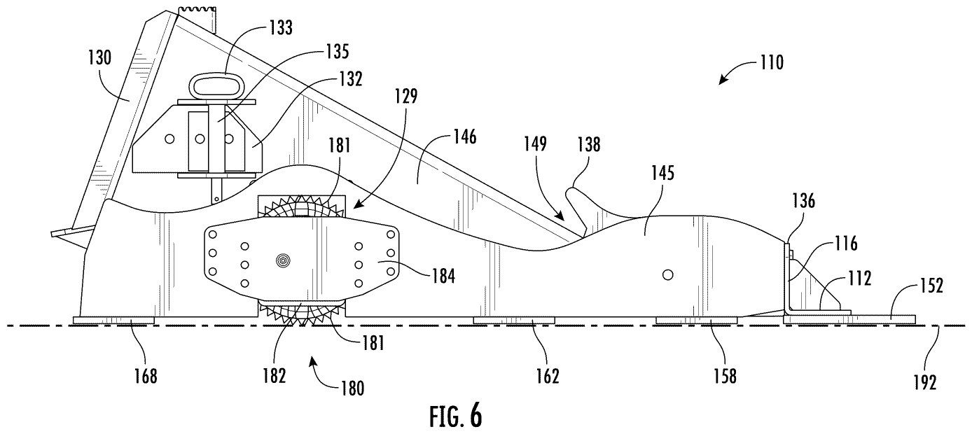

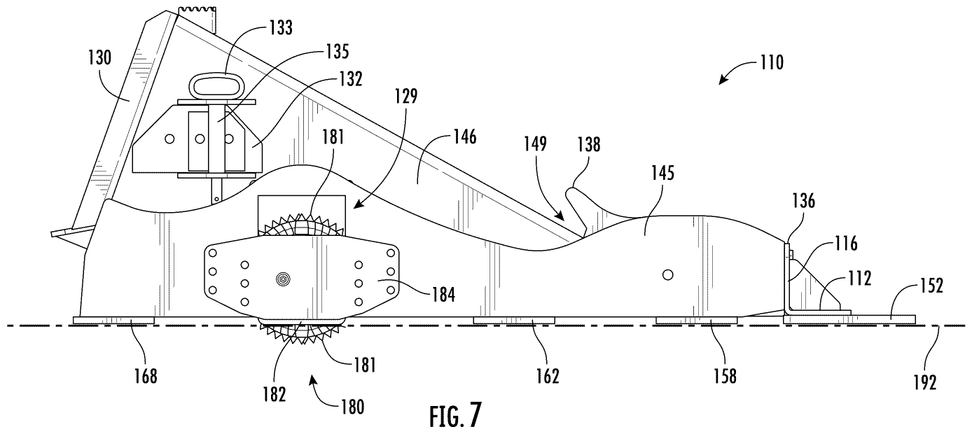

Referring to FIGS. 1-7, an implementation of a leveling bar 110 assembly is shown and described. The leveling bar 110 includes a frame 120 with one or more ground engaging bars depending from the frame 120 and aligned along a horizontal cutting plane 192 that, when the leveling bar 110 is pushed or pulled with the bars in contact with the surface of the ground, remove ground material and redistribute the material to level the surface. A rotatable drum with teeth to engage and pulverize the ground may be included to further disrupt ground material. The leveling bar 110 is manufactured, formed, or cut from metal, such as steel. In use, the leveling bar 110 is used to work the ground to level and finish a ground surface for further use, such as in preparation for recreational use, sod, seed, or hard scape such as concrete material.

The leveling bar 110 includes a recess or mounting plate 130 for connecting the leveling bar 110 to a motorized vehicle 278, such as a skid-steer vehicle for moving the leveling bar 110 along the ground. In an implementation, the mounting plate 130 is adapted to connect to a coupler of a skid-steer vehicle. Various mounting plates, skid-steer vehicles and their associated couplers and mechanical features and functions are commonly known in the art, and here, such a vehicle is not shown in the figures.

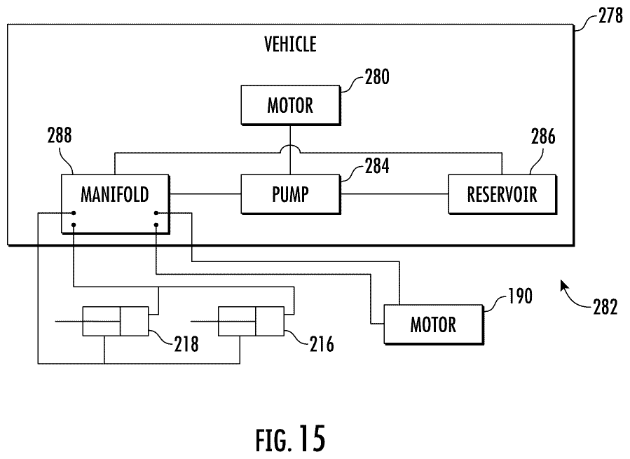

In an implementation, the leveling bar 110 includes a front bar 151 that is substantially flat and at a front end, a first center bar 158, and a drum assembly 180 adjacent a rear end with a motor 190 driven rotatable cylinder 182 presenting a plurality of teeth 181. In an implementation, the leveling bar 110 further includes one or more of a second center bar 162, a height-adjustable rotatable drum assembly 180, and a rear bar 168 or heel plate. At an end of the cylinder 182 is the motor 190 which is electrically actuated or hydraulically actuated. In an implementation, the motor 190 is connected directly to the cylinder 182. In an implementation, the motor 190 is operably connected to the cylinder 182 by a chain drive system or a gearbox. In an implementation, the motor 190 is powered by a hydraulic system 282 (FIG. 15).

The frame 120 includes several structural support members, several of which provide for attachment of the ground-engaging bars. The frame 120 has a front support 136 at a front portion for mounting the front bar 151. The front bar 151 forms a front cutting edge 150 and rear cutting edge 153, and the bar is replaceable if damaged or if it becomes worn. In an implementation, the front support 136 forms a forward-extending lower portion 112 and a raised rear portion 116. In an implementation, the front bar 151 is attached to the bottom of the lower portion 112 by fasteners, such as a nut and bolt combination, permitting replacement of the front bar 151. The front cutting edge 150 may form forward-extending spaced teeth 152. The teeth 152 permit the front cutting edge 150 to engage the surface being leveled, such as raised portions of the surface of the ground and objects on the ground, such as rocks.

Extending rearward from the front support 136 are a first side support member 141 at a left side and a second side support member 145 at a right-side forming part of the frame 120. Additional frame support members, for attaching the ground-engaging bars, extend between the side supports 141, 145. A first frame support member 124 is disposed between the front support 136 and a second frame support member 125. The first center bar 158 extends from the first side support member 141 to the second side support member 145 and is attached to the bottom of the first frame support member 124 by fasteners, such as a nut and bolt combination, permitting replacement of the first center bar 158 when it is worn or damaged. The first center bar 158 is substantially flat and includes a first front cutting edge 160 and first rear cutting edge 161 and is replaceable. The second center bar 162 extends from the first side support member 141 to the second side support member 145 and is attached to the bottom of the second frame support member 125 by fasteners, such as a nut and bolt combination, permitting replacement of the second center bar 162 is substantially flat and when it is worn or damaged. The second center bar 162 forms a second front cutting edge 164 and a second rear cutting edge 165 and is replaceable.

Rearward of the second center bar 162 is the drum assembly 180 disposed between the second frame support member 125 and a rear frame support member 123. The drum assembly 180 extends from the first side support member 141 to the second side support member 145. The rear frame support member 123 extends between the first side support member 141 and second side support member 145. The rear bar 168 extends from the first side support member 141 and second side support member 145 and is attached to the bottom of the rear frame support member 123 by fasteners, such as a nut and bolt combination, permitting replacement of the rear bar 168 when it is worn or damaged. The rear bar 168 is substantially flat and forms a front cutting edge 170 and a rear cutting edge 172 and is replaceable. Other means of attaching the bars to the frame support members include welding.

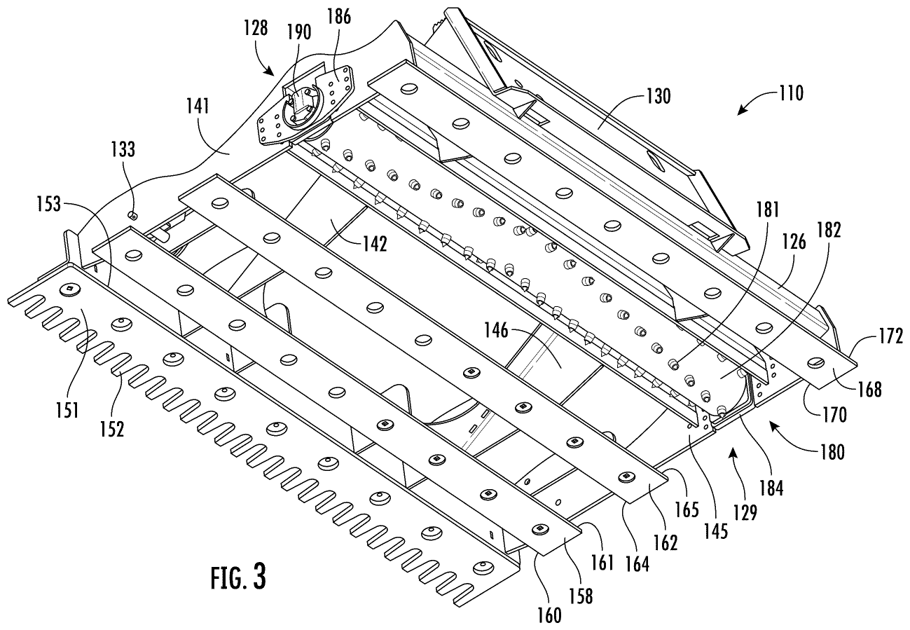

The drum assembly 180 forms an elongated cylinder 182 forming a plurality of protrusions or teeth 181 at the exterior. The arrangement of teeth 181 can be varied. The pattern of teeth 181 shown in FIG. 3 is an exemplary pattern, and any suitable pattern may be used. The teeth 181 are secured to the cylinder 182, such as by welding, or may be bolted to the cylinder 182. The cylinder 182 can present a threaded aperture that a threaded end of the teeth 181 are secured to, or a threaded end of the teeth 181 can pass through apertures in the wall of the cylinder 182 with the threaded end secured from within the cylinder 182 by nuts.

An edge guard 132 can be removably attached to the outside of the first side support member 141 and second side support member 145. The edge guard 132 is attached to the side support members 141, 145 by a removable pin 133. In an implementation, the edge guard 132 includes a sleeve 135 adapted to receive the pin 133. In an implementation, a first edge guard 132a is disposed between a first guard frame member 143 located inboard of the first side support member 141 and the first side support member 141, and apertures in the members 143, 141 slidably receive the pin 133. The first guard frame member 143 extends from the first frame support member 124 to the second frame support member 125, and may be welded thereto. In an implementation, at the right side of the frame 120 a second edge guard 132b is disposed between a second guard frame member 147 located inboard of the second side support member 145 and the second side support member 145, and apertures in the members 147, 145 slidably receive the pin 133. The second guard frame member 147 extends from the first frame support member 124 to the second frame support member 125, and may be welded thereto. When installed at outboard of the side support members, the edge guard 132 contacts and clears obstacles adjacent the leveling bar 110 and levels the surface along the side of the leveling bar 110, and serves to protect the leveling bar 110 from damage from obstacles adjacent the leveling bar 110 during use. An edge guard 132 can be attached to one or both side support members 141, 145 during use.

The ability to replace the various bars allows an operator to select a form or shape of bar for any of the associated frame support members depending on the composition of the surface to be leveled, and the anticipated objects that may be encountered. For example, ground that includes the presence of gravel, sand, dirt, clay, and mulch have different characteristics, such as workability, necessitating different bars to optimally handle the materials. Accordingly, bars with front cutting edges forming a curved conformation, angled conformation, flat conformation, spiked conformation, or toothed conformation will be more effective in working ground with particular objects, and ground with particular characteristics.

Implementation of the drum assembly 180, it is releasably connected to the side support members 141, 145, allowing adjustment to the position of the drum assembly 180 relative to the bottom of the leveling bar 110. Here, the drum assembly 180 resides within a recess formed by a drum cover 179 formed by the frame 120. The distance the cylinder 182 and teeth 181 extend below the bottom of the leveling bar 110 determines the depth the teeth 181 engage the ground below the bottom of the leveling bar 110. A first end of the cylinder 182 is operably connected to the first side support member 141 by a first side plate 186, and a second end of the cylinder 182 is operably connected to the second side support member 145 by a second side plate 184. A recess 128 in the first side support member 141 receives the first end of the drum assembly 180, and a recess 129 in the second side support member 145 receives the second end of the drum assembly 180.

Each of the side plates 186, 198 include a pattern of separate spaced openings that correspond to a pattern of separate spaced openings in each side support member 141, 145 about each respective recess 129, 130. In an implementation, the side plates 186, 198 and side support members 141, 145 form a vertical pattern of openings. The ends of the drum assembly 180 are moved vertically within the recess 128, 129 to position the points of the teeth 181 the desired distance below the bottom of the leveling bar 110. Several of the openings in the side plates 186, 184 are aligned with several of the openings in the side support member 141, 145, and bolts are passed through the aligned openings and secured with nuts to secure the drum assembly 180 in position. The location of the drum assembly 180 with respect to the frame 120 is adjusted by removing the nuts and bolts, repositioning the drum 180 upward or downward within the frame 120, and re-securing the side plates 186, 184 to the frame 120 with the bolts. In an implementation, the points of the teeth 181 are positioned between about 0 inches below the cutting plane 192 to about 3 inches below the cutting plane 192.

The skid-steer attachment mechanism or mounting plate 130 is connected to the leveling bar 110, in part, by mid-support members. A first mid-support member 142 adjacent the first side support member 141 extends from the front of the frame 120 rearward to a rear face 131 at the rear of the frame, and a second mid-support member 146 adjacent the second side support member 145 extends from the front of the frame 120 rearward to the rear face 131. In an implementation, the rear face 131 forms the mounting plate 130. The mid-support members 142, 146 intersect the second frame support member 125, drum cover 179, rear fame support member 123, and rear plate support member 126, and are welded thereto, adding structural rigidity to the frame 120.

In an implementation, the first mid-support member 142 forms a first hook member 137 with a rearwardly-open throat and hook saddle 149 accessible from the rear or second end of the frame 120, and the second mid-support member 146 forms a second hook member 138 with a rearwardly-open throat and hook saddle 149 accessible from the rear or second end of the frame 120. The hook members 137, 138 allow storage of object on the leveling bar 110, such as a bucket attachment used with the skid-steer. Such buckets are known by those skilled in the art.

The rear plate support member 126 is disposed above the rear frame support member 123, and provides an attachment point for a lower portion of the mounting plate 130. The mounting plate 130 can be metal and welded to the mid-support members 142, 146, and the rear frame support member 123, and forms a recess for receiving a quick attach plate carried by a skid loader. In an implementation, the mounting plate 130 is releasably attached to the attachment points, permitting the height of the mounting plate 130 above the cutting plane 192.

Referring to FIGS. 3-5, the right side of the leveling bar 110 is shown in elevation above the ground, showing the first center bar 158 and second center bar 162 aligned along the cutting plane 192. Referring to FIG. 3, a high position or upper positioning of the cylinder 182 with respect to the cutting plane 192 at the bottom of the leveling bar 110 is shown. In the high position, the teeth 181 at the lower portion of the cylinder 182 minimally engage the ground debris generated by the bars 158, 168, and minimally disrupt the ground surface. Use of the leveling bar 110 with the cylinder 182 in the high position may be desired if little disruption of the ground surface is desired, or if the material over which the leveling bar 110 travels is easily disrupted and would not respond well to leveling.

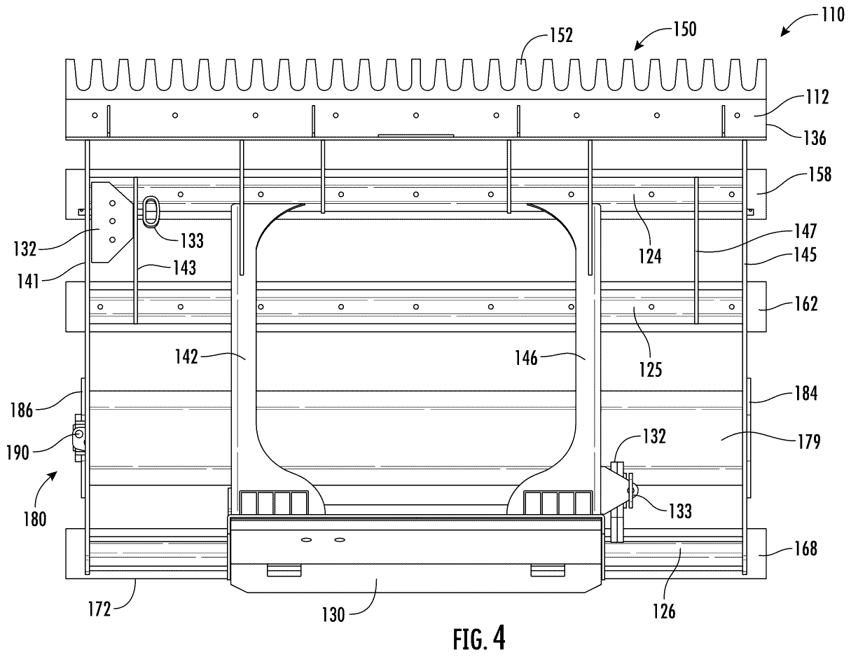

In FIG. 4, a central position of the cylinder 182 with respect to the cutting plane 192 is shown. In the central position, the teeth 181 at the lower portion of the cylinder 182 engage the ground debris generated by the bars 158, 168, and disrupt the ground surface.

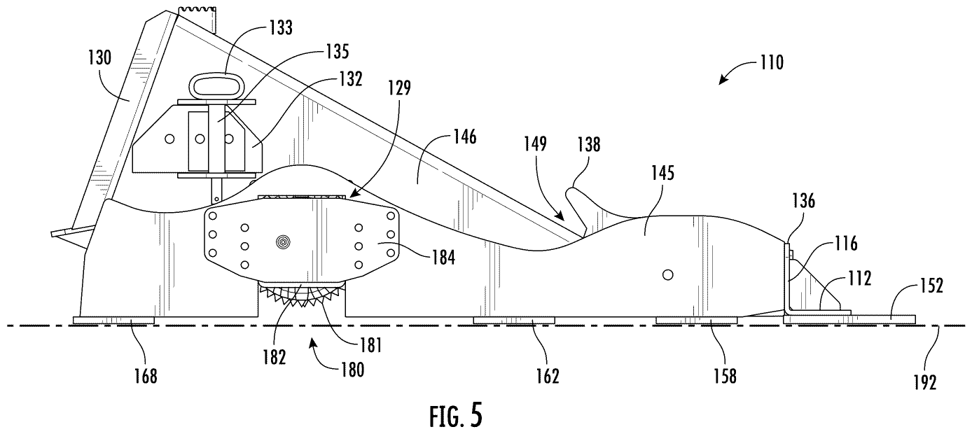

In FIG. 5, a low position of the cylinder 182 with respect to the cutting plane 192 is shown. In the low position, the teeth 181 at the lower portion of the cylinder 182 extend well below the cutting plane 192 and aggressively engage the ground and the ground debris generated by the bars 158, 168.

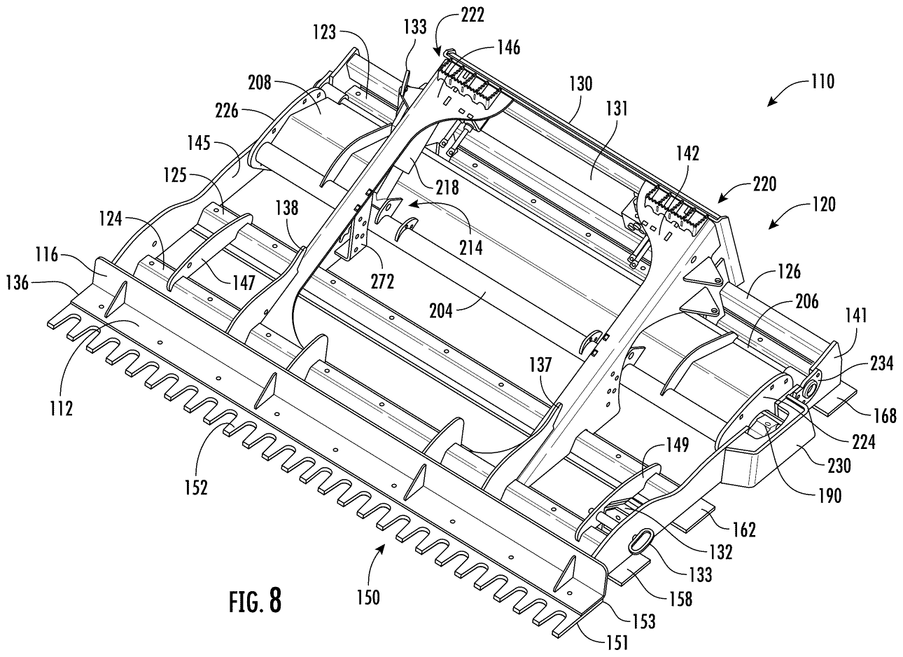

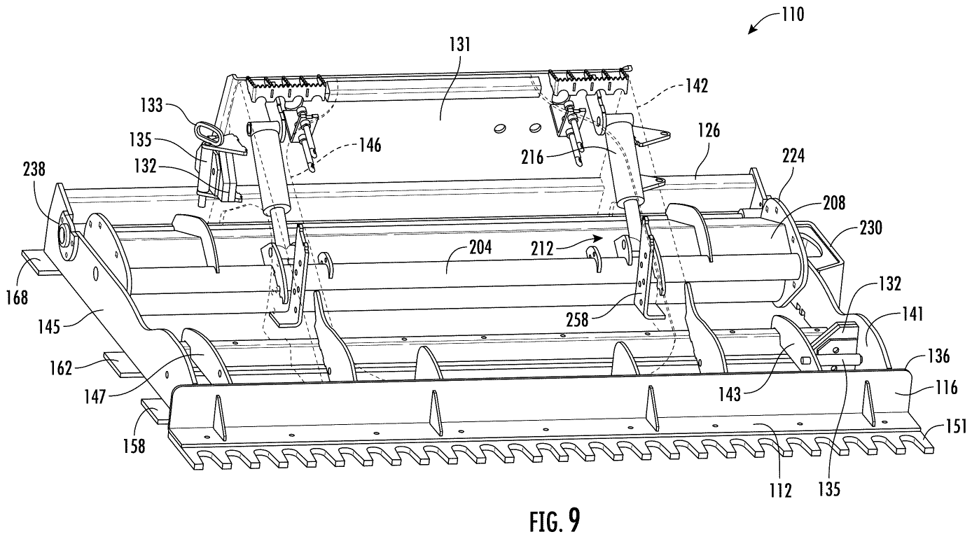

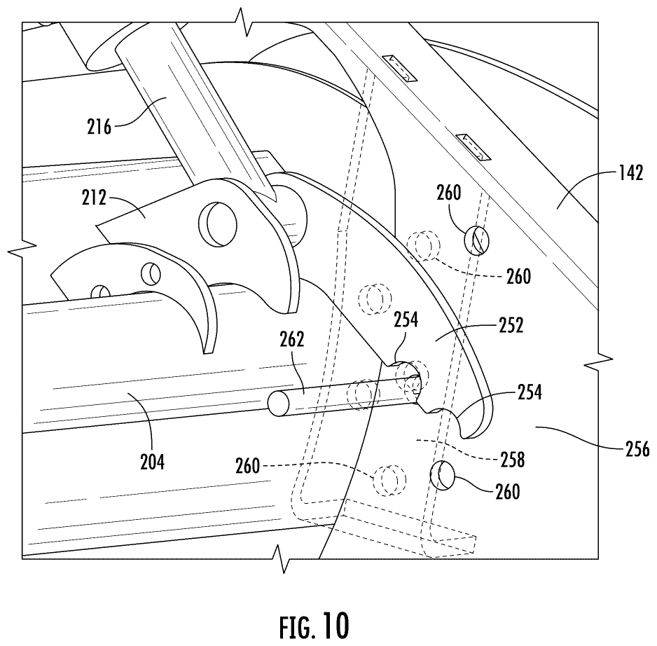

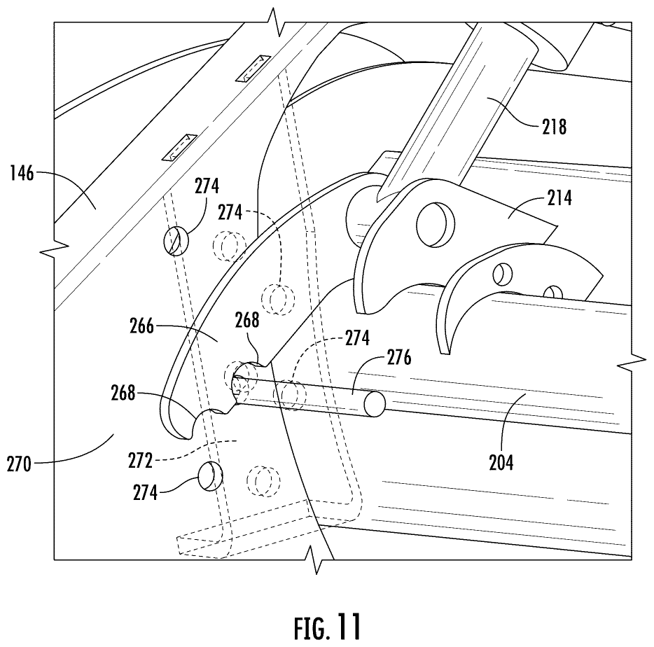

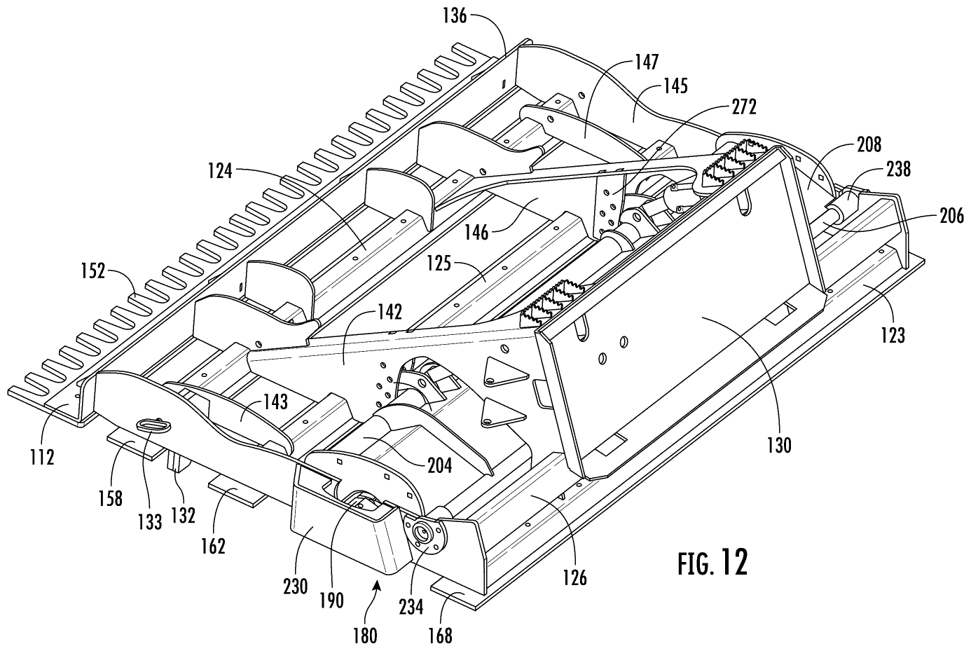

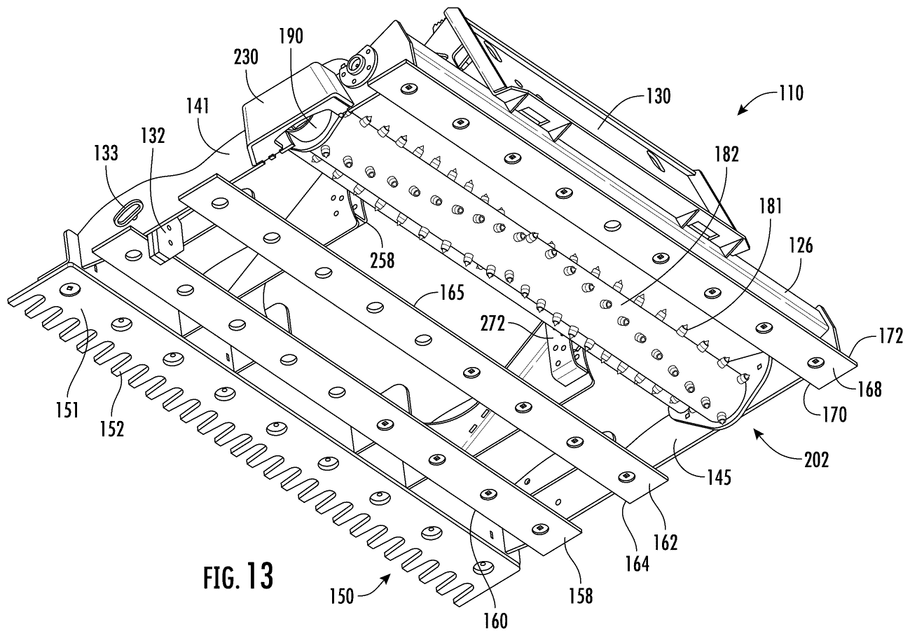

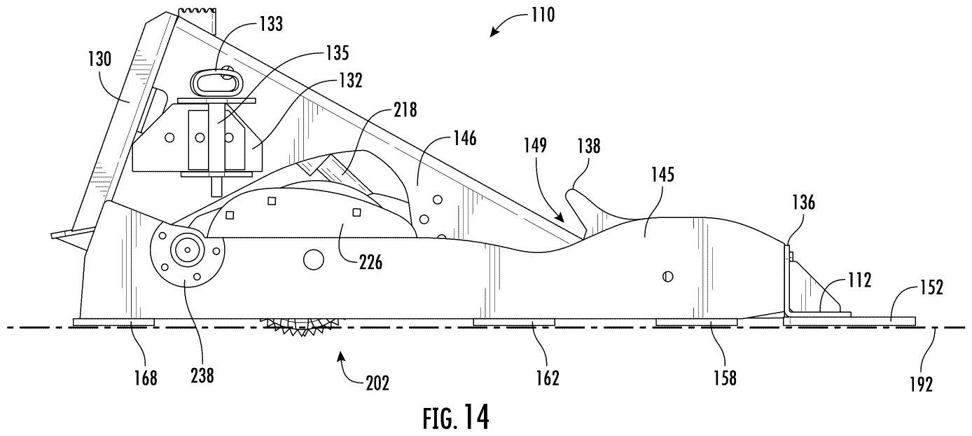

Referring to FIGS. 8-14, an implementation of the drum assembly 180 is shown where the ends of the drum assembly 180 are not connected to side support members 141, 145, allowing the vertical position of the cylinder 182 to be moved upward and downward using hydraulics. The hydraulicly positioned drum assembly 202 includes a rotatable cylinder 182 within a housing disposed between the first side support member 141 and second side support member 145. The housing is formed by a top cover 208 forming a cavity, with the top cover 208 extending from a front support 208 to a rear support 206, and laterally between a first end plate 224 at the left side and a second end plate 226 at the right side. In an implementation, the front support 208 is a tubular member welded to the top cover 208 extending along the front of the top cover 208 between the end plates 224, 226, and the rear support 206 is a tubular member extending between a first pivot assembly bracket 234 pivotally connected to the first side support member 141 and a second pivot assembly bracket 238 pivotally connected to the second side support member 145.

Hydraulic lift cylinders 216, 218 are pivotally connected to the frame 120 and the housing 210 to position the cylinder 182 with respect to the cutting plane 192. The first lift cylinder 216 resides adjacent the first mid-support member 142 and is connected at a first end to a first front bracket 212 at the front support 204 and a first rear bracket 220 at the rear face 131, and the second lift cylinder 218 resides adjacent the second mid-support member 146 and is connected at a first end to a second front bracket 214 at the front support 204 and a second rear bracket 222 at the rear face 131. The hydraulic lift cylinders 216, 218 are fluidly connected to the manifold 288 for providing hydraulic fluid to the cylinders. Retraction of the cylinder 216, 218 rods move the drum assembly 202 to a first raised position with the plurality of teeth 181 moving above the cutting plane 192 and ground, and extension of the cylinder 216, 218 rods move the drum assembly 202 to a second lowered position with the plurality of teeth 181 moving below the cutting plane 192 for engaging the ground.

In an implementation, the second lowered position of the drum assembly 202 is arrested by a drum support assembly. The drum support assembly includes a pair of arms attached to the drum assembly 202 that engage pins extending between aligned holes in adjacent side plates to stop downward movement of the drum assembly 202 during adjustment, and thereby limit the distance the teeth 181 engage the soil below the leveling bar 110. A first arm 252 extends from the first front bracket 212 forming notches 254 at a lower engagement surface. The first arm 252 extends between first and second side plates 256, 258 with an array of aligned holes 260 defined in the side plates 256, 258. In an implementation the first side plate 256 is formed by the first mid-support member 142. A removable pin 262 is passed through a set of aligned holes 260 to create a lower stop that engages a notch 254 on the first arm 252 arresting downward movement of the drum assembly 202. Similarly, a second arm 266 extends from the second front bracket 214 forming notches 268 at a lower engagement surface. The second arm 266 extends between first and second side plates 270, 272 with an array of aligned holes 274 defined in the side plates 270, 272. In an implementation the first side plate 270 is formed by the second mid-support member 146. A removable pin 276 is passed through a set of aligned holes 274 to create a lower stop that engages a notch 268 on the second arm 266 arresting downward movement of the drum assembly 202.

The motor 190 is attached to the first end plate 224 for rotating the cylinder 182 as described above. The motor 190 passes through a gap in the first side support member 141. A motor guard 230 at the outside of the first side support member 141 bridges the gap in the first side support member 141 and provides structural support for the missing portion of the side support member 141 forming the gap and provides edge protection for the motor 190.

The hydraulic system 282 can be independent of the motorized vehicle 278, or it can be part of the motorized vehicle 278. Referring to FIG. 15, an exemplary hydraulic system 282 with a hydraulic pump 284 is powered by the motorized vehicle 278 motor 280 for use with the leveling bar 110.

In an implementation, the motor 190 is fluidly connected to the hydraulic system of the skid-steer. The motor 190 is connected by hydraulic hoses to a hydraulic valve assembly of a manifold 288 and a hydraulic reservoir 286. The first and second hydraulic lift cylinders 216, 218 are operably connected to the manifold 288 and reservoir 286 by hoses. The pump 284 is operably connected to the manifold 288 and reservoir 286 by hoses. The hydraulic system 282 is operated in a conventional manner. The manifold 288 controls directional rotation of the motor 190 to rotate the cylinder 182 in a first direction or a second direction relative to the frame 120.

In use, the motorized vehicle 278 moves the leveling bar 110 along the surface of the ground with one or more ground engaging bars in contact with the ground. When moving the leveling bar 110 in a first direction, the first cutting edges engage the ground disrupting the material. When moving the leveling bar 110 in a second direction, the second cutting edges engage the ground disturbing the material. An operator can lower the cylinder 182 whereby the teeth 181 at the lower portion of the cylinder 182 extend below the cutting plane 192 depending on how deep the operator wants the teeth 181 to engage the ground.

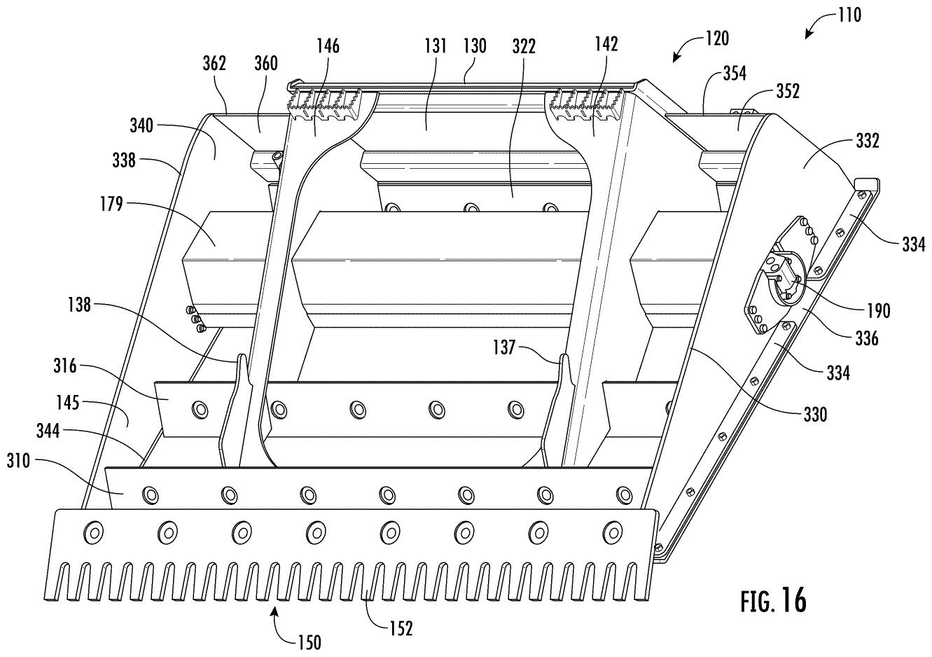

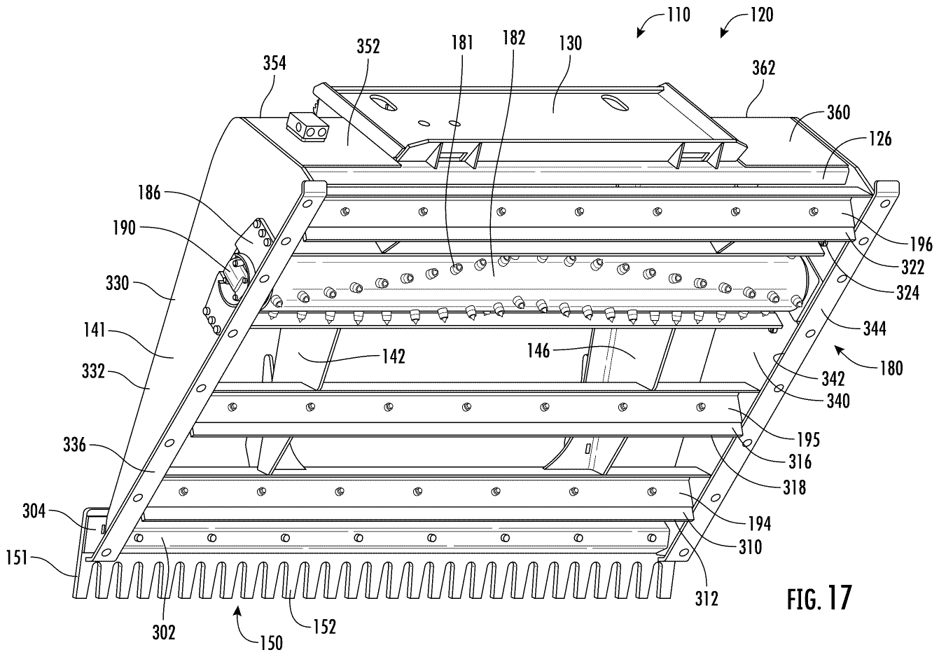

Referring to FIGS. 16-17, in an implementation, the leveling bar 110 includes ground engaging bars that are pitched downward and forward from their relative supports providing a wedge shape for channeling ground material and debris upward and rearward into the frame 120, thereby permitting the leveling bar 110 to gather ground material and debris as it moves across the surface of the ground allowing the ground material and debris to settle in low spots beneath the leveling bar 100.

The front bar 151 extends forward from a front support 302 forming an angled mounting surface 304. The mounting surface 304 extends rearward and upward so that when the front cutting edge 150 engages the surface of the ground, some ground material and debris move thought the spaced teeth 152 and some moves upward and over the front bar 151 settling between the front support 302 and first frame support member 124. A first center bar 310 forms a front cutting edge 312 extending between the first and second side support members 141, 145, and is attached to an angled mounting surface 194 of the first frame support member 124 by fasteners, such as a nut and bolt combination, permitting replacement of the bar 310. The first center bar 310 extends rearward and upward from the front cutting edge 312 so that when the edge engages the surface of the ground, ground material and debris move upward and over the bar 310 settling between the first frame support member 124 and second frame support member 125. A second center bar 316 forms a front cutting edge 318 extending between the first and second side support members 141, 145, and is attached to an angled mounting surface 195 of the second frame support member 125 by fasteners, such as a nut and bolt combination, permitting replacement of the bar 316. The second center bar 316 extends rearward and upward from the front cutting edge 318 so that when the edge engages the surface of the ground, ground material and debris move upward and over the bar 316 settling between the second frame support member 125 and the drum cover 179. A rear bar 322 forms a front cutting edge 324 extending between the first and second side support members 141, 145, and is attached to an angled mounting surface 196 of the rear frame support member 123 by fasteners, such as a nut and bolt combination, permitting replacement of the bar 322. The rear bar 322 extends rearward and upward from the front cutting edge 324 so that when the edge engages the surface of the ground, ground material and debris move upward and over the bar 322 settling between the rear frame support member 123 and the rear of the frame 120.

Side walls 332, 340, and rear plates 352, 360 aid in retaining the ground materials and debris within the frame 120. The first side support member 141 forms the side wall 332 extending from a lower edge 334 to an upper edge 330, and the second side support member 145 forms the side wall 340 extending from a lower edge 342 to an upper edge 338. The upper edges 330, 338 extend upward and rearward from the front support 302, terminating at the rear of the frame 120. A rear wall is formed by the rear face 131 and a first rear plate 352 and second rear plate 360 prevent materials and debris from exiting the rear of the leveling bar 110. The first rear plate 352 extends between the side wall 332 and mounting plate 130, and terminates at an upper edge 354, and the second rear plate 360 extends between the side wall 350 and mounting plate 130, and terminates at an upper edge 362. A replaceable wear strip 336 attached to the lower edge 334 and a replaceable wear strip 344 attached to the lower edge 342 serves to protect the frame 120 from wear, and operates as adjustable feet or skis, whereby the thickness can be varied to set the distance the teeth 181 of the drum assembly 180 extend below the cutting plane 192.

It is understood that the present subject matter may be embodied in many different forms and should not be construed as being limited to the embodiments set forth herein. Rather, these embodiments are provided so that this subject matter will be thorough and complete and will convey the disclosure to those skilled in the art. Indeed, the subject matter is intended to cover alternatives, modifications, and equivalents of these embodiments, which are included within the scope and spirit of the subject matter as defined by the appended claims and their equivalents. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims.

Having described the disclosed subject matter, what is claimed as new and desired to be secured by letters patent is:

1. An earth working apparatus, comprising:
a frame extending between a first end and a second end;
a front bar connected to the frame at the first end, wherein the front bar forms a first front cutting edge for engaging the earth; and
a drum assembly connected to the frame adjacent the second end, the drum assembly comprising:
a rotatable drum forming a plurality of protrusions for engaging the earth.

2. The earth working apparatus of claim 1, comprising:
wherein the first front cutting edge forms a plurality of forward extending spaced teeth.

3. The earth working apparatus of claim 1, comprising:
a first center bar connected to the frame between the front bar and the rotatable drum, wherein the first center bar forms a second front cutting edge for engaging the earth; and
a second center bar connected to the frame in a position between the first center bar and the rotatable drum, wherein the second center bar forms a third front cutting edge for engaging the earth.

4. The earth working apparatus of claim 3, comprising:
wherein the first center bar extends rearward and upward from the second front cutting edge.

5. The earth working apparatus of claim 1, comprising:
a rear bar connected to the frame adjacent the second end, wherein the rear bar forms a fourth front cutting edge for engaging the earth.

6. The earth working apparatus of claim 1, comprising:
an attachment plate connected to the frame at the second end.

7. The earth working apparatus of claim 1, comprising:
wherein the frame includes a first side support and a second side support;
wherein the rotatable drum extends between a first end releasably connected to the first side support member, and a second end releasably connected to the second side support member.

8. The earth working apparatus of claim 7, comprising:
wherein the first side support forms a lower edge; and
a replaceable wear strip mounted at the lower edge.

9. The earth working apparatus of claim 1, comprising:
wherein the frame includes a first side support member and a second side support member;
wherein the drum assembly is disposed between the first side support member and second side support member and vertically movable therebetween;
wherein the drum assembly has a raised position with the plurality of protrusions lifted above the ground, and a lowered position for engaging the earth; and
a lift actuator connected to the drum assembly and configured for moving the drum assembly between the raised position and the lowered position.

10. The earth working apparatus of claim 9, comprising:
an arm extending from the drum assembly, wherein the arm forms a lower engagement surface;
a side plate forming a first hole;
a pin adapted for engaging the first hole; and
wherein the lower engagement surface is adapted to engage the pin to stop moment of the drum assembly at the lowered position.

11. The earth working apparatus of claim 1, comprising:
wherein the frame includes a first mid-support member and a second mid-support member;
wherein the first mid-support member extends from the first end to the second end;
wherein the second mid-support member extends from the first end to the second end; and
an attachment plate connected to the first mid-support member and second mid-support member at the second end.

12. The earth working apparatus of claim 10, comprising:
wherein the first mid-support member forms a first hook member with a rearwardly open throat accessible from the frame second end; and
wherein the second mid-support member forms a second hook member with a rearwardly open throat accessible from the frame second end.

13. The earth working apparatus of claim 1, comprising:
wherein the frame comprises:
a first side wall extending from a first lower edge to a first upper edge;
a second side wall opposite the first side wall, the second side wall extending from a second lower edge to a second upper edge;
a rear wall at the second end of the frame;
wherein the first upper edge extends upward and rearward from the frame first end to the frame second end;
wherein the second upper edge extends upward and rearward from the frame first end to the frame second end;
a first wear strip at the first lower edge; and
a second wear strip at the second lower edge.

14. An earth working apparatus, comprising:
a frame extending between a first end and a second end;
a front bar connected to the frame at the first end, wherein the front bar forms a first front cutting edge for engaging the earth;
a rear bar connected to the frame adjacent the second end, wherein the rear bar forms a second front cutting edge for engaging the earth; and
a drum assembly connected to the frame in a position between the front bar and the rear bar, the drum assembly comprising:
a rotatable drum forming a plurality of protrusions for engaging the earth.

15. The earth working apparatus of claim 14, comprising:
wherein the first front cutting edge forms a plurality of forward extending spaced teeth.

16. The earth working apparatus of claim 14, comprising:
an attachment plate connected to the frame at the second end.

17. The earth working apparatus of claim 14, comprising:
wherein the frame includes a first side support and a second side support;
wherein the rotatable drum extends between a first end connected to the first side support member, and a second end connected to the second side support member.

18. The earth working apparatus of claim 14, comprising:
wherein the frame includes a first mid-support member and a second mid-support member;
wherein the first mid-support member extends from the first end to the second end;
wherein the second mid-support member extends from the first end to the second end; and
an attachment plate connected to the first mid-support member and second mid-support member at the second end.

19. The earth working apparatus of claim 18, comprising:
wherein the first mid-support member forms a first hook member with a rearwardly open throat accessible from the frame second end; and
wherein the second mid-support member forms a second hook member with a rearwardly open throat accessible from the frame second end.

20. The earth working apparatus of claim 14, comprising:
wherein the frame includes a first side support member and a second side support member;
wherein the drum assembly is disposed between the first side support member and second side support member and vertically movable therebetween;
wherein the drum assembly has a raised position with the plurality of protrusions lifted above the ground, and a lowered position for engaging the earth; and
a lift actuator connected to the drum assembly and configured for moving the drum assembly between the raised position and the lowered position.

21. The earth working apparatus of claim 20, comprising:
an arm extending from the drum assembly, wherein the arm forms a lower engagement surface;
a side plate forming a first hole;
a pin adapted for engaging the first hole; and
wherein the lower engagement surface is adapted to engage the pin to stop movement of the drum assembly at the lowered position.

22. The earth working apparatus of claim 14, comprising:
wherein the frame comprises:
a first side wall extending from a first lower edge to a first upper edge;
a second side wall opposite the first side wall, the second side wall extending from a second lower edge to a second upper edge;
a rear wall at the second end of the frame;
wherein the first upper edge extends upward and rearward from the frame first end to the frame second end;
wherein the second upper edge extends upward and rearward from the frame first end to the frame second end;
a first wear strip at the first lower edge; and
a second wear strip at the second lower edge.

23. A ground working apparatus, comprising:
a frame extending between a front end and a rear end, the frame comprising:
a first side support member extending from the front end to the rear end;
a second side support member extending from the front end to the rear end;
a first mid-support member extending from the front end;
wherein the first mid-support member is disposed between the first side support member and second side support member, and wherein the first mid-support member forms a first hook member;
a second mid-support member extending from the front end;
wherein the first mid-support member is disposed between the first mid-support member and second side member, and wherein the second mid-support member forms a second hook member;
an attachment plate connected to the frame at the rear end;
a front bar connected to the frame at the front end, wherein the front bar forms a first front cutting edge for engaging the ground, the first front cutting edge comprising:
a plurality of forward extending spaced teeth;
a rear bar connected to the frame adjacent the rear end, wherein the rear bar forms a second front cutting edge for engaging the ground;
a drum assembly connected to the frame in a position between the front bar and the rear bar, the drum assembly comprising:
a rotatable drum forming a plurality of protrusions for engaging the ground;
a first center bar connected to the frame in a position between the front bar and the drum assembly, wherein the first center bar forms a third front cutting edge for engaging the ground; and
a second center bar connected to the frame in a position between the first center bar and the drum assembly, wherein the second center bar forms a fourth front cutting edge for engaging the ground.

24. The ground working apparatus of claim 23, comprising:
wherein the drum assembly has a raised position with the plurality of protrusions lifted above the ground, and a lower position for engaging the ground; and
a lift actuator connected to the drum assembly and configured for moving the drum assembly between the raised position and the lowered position.

25. The ground working apparatus of claim 24, comprising:
an arm extending from the drum assembly, wherein the arm forms a lower engagement surface;
a side plate forming a first hole;
a pin adapted for engaging the first hole; and
wherein the lower engagement surface is adapted to engage the pin to stop movement of the drum assembly at the lowered position.
